(19) United States
(12) Patent Application Publication
(10) Pub. No.: US 2007/0239438 A1
(43) Pub. Date: Oct. 11, 2007

(54) Digital microphone system and method thereof

(76) Inventors: Tsung-Peng Chuang, Hsinchu (TW); Chia-Sheng Tsai, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/730,939

(22) Filed: Apr. 5, 2007

(30) Foreign Application Priority Data
Apr. 6, 2006 (TW) 095112264

(51) Int. Cl. G10L 21/00

(52) U.S. Cl. 704/212

(57) ABSTRACT

A digital microphone system and a method thereof are described. The digital microphone comprises a receiving unit, an amplifier, a modulator, an audio processing unit and a high definition audio link. After the receiving unit receives an analog audio signal, the analog audio signal is amplified by the amplifier. The analog audio signal is then converted into a first digital data by the modulator. The high definition audio link is set between the modulator and the audio processing unit for transmitting the first digital data. The audio processing unit comprises a digital filter for converting the first digital data into a second digital data. The audio processing unit and the digital filter are integrated and implemented by software.

### FIELD OF THE INVENTION

The present invention relates to a digital microphone system and a method thereof, and more particularly to a digital microphone system and a method thereof that transmit digital signals through a High Definition Audio Link (HDA Link).

### BACKGROUND OF THE INVENTION

A microphone is a device that can convert sound waves into electronic signals. Traditionally, a microphone comes with an analog design and uses a piezoelectric transistor or a capacitor to convert a pressure wave hitting a surface of the microphone into an analog output signal. In other words, a sound wave drives a charged film to produce vibrations, and an analog signal is generated according to a voltage change across capacitors. The analog signal is then amplified, and finally transmitted to a recording device. However, the shortcoming of the traditional analog microphone resides in that analog signals generated are very sensitive to external interferences, so that the quality of analog signals becomes very unstable and easily affected by external interferences.

As electronic components evolve, the operation speed of personal computer systems has reached a category of several GHz. If an analog microphone is connected externally to or embedded in the personal computer system, then external interferences inherent in the computer system, such as high-frequency noises coming through a printed circuit board (PCB) due to high-speed operation, tend to seriously affect the retrieval and transmission path of analog audio signals, and consequently the quality of analog signals will degrade adversely.

Therefore, some manufacturers proposed a design of digital microphone for receiving analog audio signals and representing them in digital form before transmission. The digital signals so transmitted; that is, in digital format, will be immune from noises, and thus the influence of external interferences on the retrieved audio signals can be alleviated. Basically, the concept of digital microphone adopts a digit sampling mechanism to convert an analog signal of the microphone into a digital signal, and then uses a dedicated hardware such as an audio CODEC chip to perform a digital filtering operation, and the audio data in a format suitable for storage and playback (such as the PCM format) is transmitted to the computer system for storage and/or later playback. Since the audio signals have been converted into a digital form at the early stage of receiving the signals, the audio signals will not be contaminated by the various noise sources when passing through the transmission path.

However, using dedicated hardware such as audio CODEC chips for digital data processing (such as filtering operations) tends to restrain flexibility of the system with the hardware design, and providing the foregoing functions incurs a high cost on the hardware part.

### SUMMARY OF THE INVENTION

It is therefore one of objectives of the present invention is to provide a digital microphone system and a method thereof for transmitting digital signals through High Definition Audio Link (HDA Link).

Another objective of the present invention is to provide a digital microphone system and a method thereof that uses the computational capacity of a host system to implement digital data processing function(s) such as filtering in a software manner.

In a preferred embodiment of the present invention, a microphone system comprises: a digital microphone module for receiving an external sound wave vibration to generate a corresponding data of a first digital format; an audio CODEC chip coupled to the digital microphone module for receiving and transmitting the data of the first digital format; a memory for storing a software program code; and a processing unit coupled to the memory and the audio CODEC chip for performing a digital filter operation for the data of the first digital format from the audio CODEC chip to generate a corresponding data of a second digital format according to the software program code stored in the memory.

In a preferred embodiment of the present invention, another personal computer system comprises a digital microphone module for receiving an external sound wave vibration, and the digital microphone module comprises a sigma-delta modulator for producing a digital data of a first format; a transmission interface coupled to the digital microphone module for transmitting the digital data; a memory provided by the sigma-delta modulator for storing a software program code; and a processing unit coupled to the memory and the transmission interface according to the software program code stored in the memory to perform an audio processing operation for the data of the first digital format transmitted through the transmission interface to generate a corresponding data of a second digital format.

In a preferred embodiment of the present invention, a sound recording method comprises the steps of converting an external sound wave vibration into a data of a first digital format; transmitting the data of the first digital format through a serial link interface; using a processing unit to perform a digital filter operation for the data of the first digital format by software to generate a data of a second digital format; and storing the data of the second digital format.

The objectives of the invention, its structure, innovative features, and performance become apparent by referring to the preferred embodiment as disclosed in the following detailed description of the invention together with the attached drawings.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 is a schematic block diagram of a digital microphone system in accordance with a preferred embodiment of the present invention; and

FIG. 2 is a schematic block diagram of a digital microphone applied to a computer system in accordance with a preferred embodiment of the present invention.

### DETAILED DESCRIPTION OF THE PREFERRED EMBODIMENTS

The present invention relates to a digital microphone system and a method thereof. While the specifications describes several example embodiments of the invention, it should be understood that the invention can be implemented in many way and is not limited to the particular examples described below or to the particular manner in which any features of such examples are implemented.

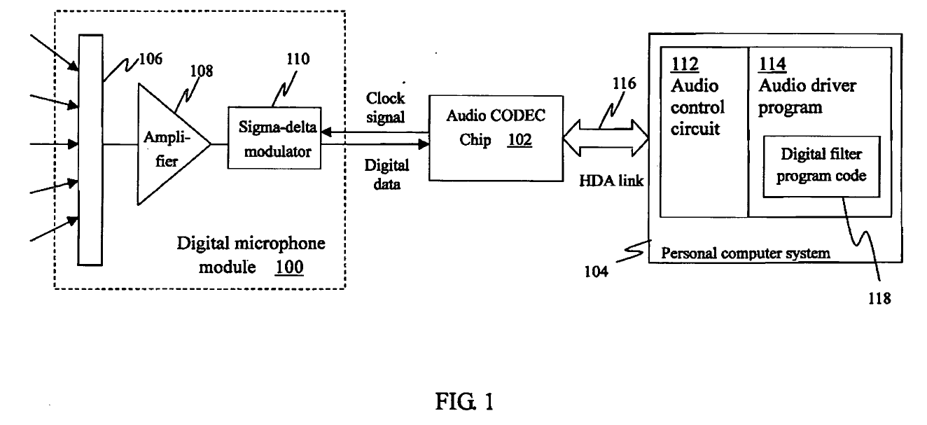

Referring to FIG. 1 for a schematic view of a digital microphone system in accordance with a preferred embodiment of the present invention, the digital microphone system comprises a digital microphone module 100 for receiving an external audio signal, and transmitting the received audio signal through an audio CODEC chip 102 to a personal computer system 104 for processing and storage. In general, a digital microphone system of this sort is installed on a printed circuit board (PCB) such as a motherboard of the personal computer system 104, wherein the digital microphone module 100 can be connected to the motherboard through a phone jack or built in the motherboard, and the audio CODEC chip 102 is usually soldered directly onto the motherboard, or installed on a sound card, and the personal computer system 104 usually includes a central processing unit (CPU), a chipset, and a memory installed on a motherboard, and its interconnecting wirings and buses.

It is to be noted that although a personal computer system is used as an example for the illustration of the invention, people skilled in the art will understand that the digital microphone system in accordance with this embodiment is not limited to be used in a personal computer only, but can be applied to other digital audio/video systems or multimedia systems as well.

In a preferred embodiment as disclosed in FIG. 1, the digital microphone module 100 includes a receiving unit 106 for receiving an external sound wave vibration and converting the sound wave vibration into an analog signal of electronic form, and then an amplifier 108 amplifies the analog signal, and the amplified analog signal is sampled and modulated by a sigma-delta modulator 110 and is converted into a corresponding digital signal. Because the implementation and operation principle of sigma-delta modulation is within the knowledge of people of ordinary skill in the relevant art, and the sigma-delta modulator 110 of this embodiment converts the analog signal into 1-bit digital data, or digital data of 1-bit width, as is the common practice in the field of sigma-delta modulation, its detailed operating principle and realization will not be herein described. It is to be noted that a clock signal used for sampling in the sigma-delta modulator 110 of this embodiment is produced and provided by an audio CODEC chip 102 at a later stage, but the present invention is not limited to such arrangement.

In this preferred embodiment, the 1-bit digital data generated by the sigma-delta modulator 110 will be transmitted to the audio CODEC chip 102. The audio CODEC chip 102 is a well-known device used in the field of audio processing, and it usually includes two main parts, one for audio input and the other for audio output, for assisting the host system with the operations of coding, decoding, and inputting/outputting audio signals. In this preferred embodiment, the audio CODEC chip 102 bypasses the received 1-bit digital data and directly sends them to the personal computer system 104. However, the audio CODEC chip 102 in other embodiments can perform audio processing on the digital data to various extents.

In general, in the personal computer system 104 a hardware audio processing circuit 112 and a software audio driver program 114 are used for carrying out the audio processing and control, wherein the audio driver program 114, which belongs in the software domain, includes a program code for instructing and controlling the operation of the audio processing circuit 112 and the audio CODEC chip 102, both of which belong to the hardware domain. Further, a digital filter program code 118 is also provided for filtering the 1-bit digital data. After the 1-bit digital data is filtered by software, the digital data is then converted into a data of a digital format suitable for storage and for use by application programs, such as the Pulse Code Modulation, or PCM format, and is stored into the memory of the personal computer system 104.

It is to be noted that the audio CODEC chip 102 of this preferred embodiment further uses a serial link interface such as a High Definition Audio (HDA) Link 116 for exchanging data with the personal computer system 104, and takes the advantages of broader bandwidth and higher transmission rate of a serial link interface, to facilitate the transmission of an enormous amount of data, such as the 1-bit digital data in accordance with this embodiment. However, the use of serial link is not essential to the present invention.

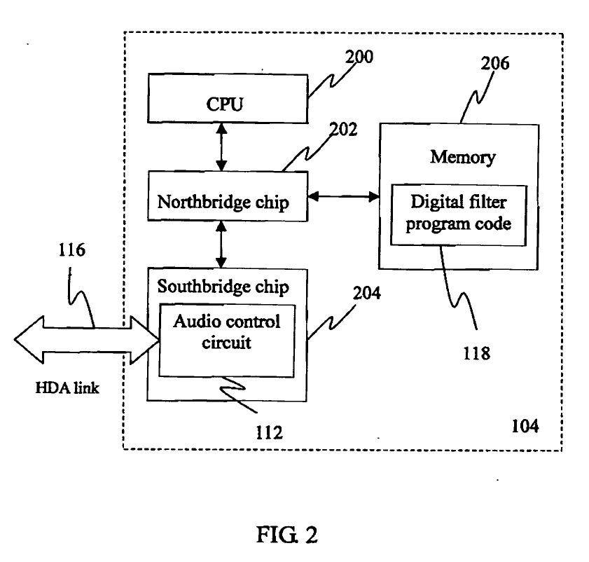

Referring to FIG. 2 for a schematic view of a personal computer system 104 in accordance with a preferred embodiment of the present invention, a widely-seen personal computer system comprises a central processing unit (CPU) 200, and a chipset, such as the combination of a Northbridge chip 202 and a Southbridge chip 204, for assisting the operations of the CPU 200, and a memory 206, such as a DRAM, for storing software program codes and the digital data. Since these components are well known in the pertinent art, their detailed operation and composition will not be described herein. It is to be noted that the foregoing described embodiment merely serves as one of the many realizations of a personal computer system, and people skilled in the art will understand that the present invention can be applied to computer systems of a different architecture or to other audio processing or multimedia systems as well.

Referring to FIG. 2, the audio processing circuit 112 is an integrated circuit which forms a portion of the Southbridge chip 204, and is coupled to the audio CODEC chip 102 through the HDA link 116. The foregoing-mentioned 1-bit digital data is transmitted to the personal computer system 104 through the audio CODEC chip 102 and the audio processing circuit 112, and is temporarily stored in the memory 206. Then, the central processing unit (CPU) 200 uses its computational capacity to perform a digital filter operation on the 1-bit digital data in a software manner according to the instruction of the digital filter program code 118 (which is a portion of the audio driver program 114) stored in the memory 206. In this preferred embodiment, the software-based digital filter operation performs a series of downsampling and filtering operations (such as 1+z⁻¹ filtering, or FIR filtering) on the 1-bit digital data, until the frequency drops to 1/64 of its original value, which process is also referred to as “demodulation”, and the digital audio data so produced is in PCM format. This data in PCM format will then be stored in the memory 206, or further stored in another non-volatile memory device such as a hard disk to complete a sound recording procedure.

The foregoing embodiment of the present invention employs the advantages of new applications including the high-speed transmission rate of recently developed serial transmission interfaces (such as a HDA link) and the enhanced processing performance of the CPU (with a operational frequency of 2-3 GHz or higher), to transmit a large quantity of intermediate data through a high-speed link interface to the host system, and uses a high-performance processing unit to perform a digital filter operation on the intermediate data in a software manner as part of an integral audio processing and recording procedure, so as to lower the hardware cost (such as the level of complexity of the audio CODEC chip) and improve the flexibility of system design. With this concept, the design of audio processing system may even be implemented without involvement of an audio CODEC chip, and replace its function with software computation.

It is to be further noted that although the HDA link specification proposed by Intel is designed and used for transmitting data of three types of formats: PCM, AC3, and Floating32, the HDA link in the foregoing preferred embodiments is nevertheless used for transmitting the 1-bit digital data, in order to transmit the sampling result of the sigma-delta modulator 110 to the personal computer system 104 for further computations, albeit explicit recommended use in HAD link specification.

Such a digital microphone system which performs digital filter operation in software domain has the advantage of providing better flexibility of system design, such as capable of being designed to process signals and data in various data formats including a different bit number or a different sampling rate. The function of volume control can also be so integrated into the software-based digital filter operation, where traditionally the volume control operation can only be achieved with a dedicated hardware circuit, but in software computation it can be easily achieved by changing a multiplication factor in the process of converting the 1-bit digital data into PCM format.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A microphone system, comprising:
a digital microphone module, for receiving an external sound wave vibration to generate a corresponding data of a first digital format;
an audio CODEC chip, coupled to said digital microphone module, for receiving and transmitting said data of said first digital format;
a memory, for storing a software program code; and
a processing unit, coupled to said memory and said audio CODEC chip, for performing a digital filter operation on said data of said first digital format from said audio CODEC chip to generate a corresponding data of a second digital format according to said software program code stored in said memory.

2. The microphone system of claim 1, wherein said first digital format represents data with a bit width of one bit.

3. The microphone system of claim 2, wherein said digital microphone module includes a sigma-delta modulator for producing said data of said first digital format being represented with a bit width of one bit.

4. The microphone system of claim 3, wherein said audio CODEC chip generates a clock signal and transmits said clock signal to said sigma-delta modulator as a sampling clock of said sigma-delta modulator.

5. The microphone system of claim 1, further comprising a HDA link coupled between said audio CODEC chip and said processing unit for transmitting said data of said first digital format.

6. The microphone system of claim 1, wherein said second digital format is PCM format.

7. A personal computer system, comprising:
a digital microphone module, for receiving an external sound wave vibration, and including a sigma-delta modulator for producing data of a first digital format;
a transmission interface, coupled to said digital microphone module, for transmitting said data of said first digital format generated by said sigma-delta modulator;
a memory, for storing a software program code; and
a processing unit, coupled to said memory and said transmission interface, for performing audio processing on said data of said first digital format transmitted through said transmission interface according to said software program code stored in said memory, so as to generate corresponding data of a second digital format.

8. The personal computer system of claim 7, wherein said first digital format represents data with a bit width of one bit.

9. The personal computer system of claim 7, wherein said transmission interface is a serial link interface.

10. The personal computer system of claim 9, wherein said transmission interface is an HDA link.

11. The personal computer system of claim 7, further comprising an audio CODEC chip coupled between said digital microphone module and said transmission interface.

12. The personal computer system of claim 7, wherein said audio processing performed by said processing unit includes a digital filter operation.

13. The personal computer system of claim 12, wherein said audio processing performed by said processing unit further includes a downsampling operation.

14. The personal computer system of claim 7, wherein said second digital format is PCM format.

15. The personal computer system of claim 7, further comprising a Southbridge chip and a Northbridge chip, both coupled between said transmission interface and said processing unit.

16. A sound recording method, comprising the steps of:
converting an external sound wave vibration into data of a first digital format;
transmitting said data of said first digital format through a serial link interface;
using a processing unit to perform a digital filter operation on said data of said first digital format to generate data of a second digital format; and
storing said data of said second digital format.

17. The sound recording method of claim 16, further comprising:
reading a software program code from a memory as a basis of performing said digital filter operation.

18. The sound recording method of claim 16, further comprising:
using said processing unit to perform a downsampling operation on said data of said first digital format in a software manner.

19. The sound recording method of claim 16, further comprising:
using said processing unit to perform a volume adjustment operation on said data of said first digital format in a software manner.

20. The sound recording method of claim 16, wherein said second digital format is PCM format.

21. The sound recording method of claim 16, wherein said serial link interface is an HDA link.
